(19) United States
(12) Patent Application Publication
(10) Pub. No.: US 2007/0236408 A1
(43) Pub. Date: Oct. 11, 2007

(54) Computing device, computing device system and power control method

(75) Inventors: Hajime Yamaguchi, Yokohama-Shi (JP); Shinya Murai, Kawasaki-Shi (JP); Shogo Yamaguchi, Kawasaki-Shi (JP); Mitsue Fujinuki, Tokyo (JP); Tsuyoshi Hioki, Yokohama-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/723,407

(22) Filed: Mar. 19, 2007

(30) Foreign Application Priority Data
Mar. 30, 2006 (JP) 2006-94418

(51) Int. Cl. G09G 5/00

(52) U.S. Cl. 345/1.1

(57) ABSTRACT

There is provided with a computing device including: a coupler configured to couple to a display device having a chargeable first battery and be able to be separated from the display device, wherein charging to the first battery and wired communication with the display device can be performed via the coupler at a time of being coupled to the display device; a detector configured to detect whether the coupler is coupled to the display device; a wireless communicator configured to communicate wirelessly with the display device when separated from the display device; a connector configured to be supplied with power from an external power supply; a chargeable second battery; a further detector configured to detect whether power is supplied to the connector; and a controller configured to control charging and discharging of the first and second battery based on whether the power is supplied when coupled to the display device.

### CROSS-REFERENCE TO RELATED APPLICATIONS

This application is based upon and claims the benefit of priority from the prior Japanese Patent Applications No. 2006-94418 filed on Mar. 30, 2006, the entire contents of which are incorporated herein by reference.

### BACKGROUND OF THE INVENTION

1. Field of the Invention

The present invention relates to a computing device that can be separated from and coupled to a display device, a computing device system and a power control method.

2. Related Art

Mobile computing is spreading as computer and communication technologies represented by personal computers and portable telephones are in progress. Above all, spread of notebook computers including wired and wireless communication devices is remarkable. The notebook computer is obtained by forming a display device and a computing device as one body. However, portability and use convenience required for mobiles and the system performance are in a trade-off relation. For example, if a high-frequency clock CPU (Central Processing Unit) or GPU (Graphics Processing Unit) is used, then the power dissipation becomes high and it becomes necessary to mount a heavier large-capacity battery. On the other hand, if the light weight and thin shape are pursued, it is inevitable to lower the performance of the CPU or GPU. In a notebook computer raised in convenience by mounting an optical drive, its total weight increase, this makes the utilization form of the personal computer close to that of a desktop personal computer placed on a desk and used, and it is therefore difficult to say that the utilization form is mobile computing. On the other hand, paying attention to the display device included in the notebook computer, its advance in thin shape and light weight is remarkable.

As one method for reconciling the portability and convenience in use of the thin light-weight display device and high system performance of the computing device, it is conceivable to make the display device separable from the computing device. It can be implemented by displaying screen information sent from the computing device in a wireless form, on the display device. If it is more convenient to use the display device and the computing device as one body in input work using a keyboard, then the display device should be coupled to the computing device and the computing device should send screen information to the display device in a wired form as usual.

If a display device of a computing device system such as a notebook computer which might be driven by a battery is made separable, power management of the battery for the computing device and the display device becomes an important. However, the problems have not been solved.

JP-A2002-304283(KOKAI), JP-A2002-312155(KOKAI), and JP-A2004-86550(KOKAI) disclose examples in which the display device is separable, and screen information is sent out in a wireless form and displayed on the display device when the display device is separated. When the display device is separated, the display device is driven by a mounted battery in many cases. The JP-A2002-304283(KOKAI), JP-A2002-312155(KOKAI), and JP-A2004-86550(KOKAI) describe only that the computing device is driven by power supply such as an AC adapter other than the battery and the computing device can run the display device and charge a battery in the display device. In JP-A2000-99204(KOKAI), JP-A2001-5564(KOKAI), and JP-A2002-215265(KOKAI) as well, an information processing device from which a display device can be separated is described, but power management of a battery is not mentioned. On the other hand, an example in which a battery is mounted on each of a display device in a notebook computer and a computing device other than the display device is described in JP-A2002-110122(KOKAI). However, the display device is not separable, and there is no description concerning power management of the two batteries.

### SUMMARY OF THE INVENTION

According to an aspect of the present invention, there is provided with a computing device comprising:

a coupler configured to couple to a display device having a chargeable first battery and be able to be separated from the display device, wherein charging to the first battery and wired communication with the display device can be performed via the coupler at a time of being coupled to the display device;

a coupling detector configured to detect whether the coupler is coupled to the display device;

a wireless communicator configured to communicate wirelessly with the display device when the coupler is being separated from the display device;

an external power supply connector configured to be supplied with power from an external power supply;

a chargeable second battery;

a connection detector configured to detect whether power is supplied to the external power supply connector; and

a controller configured to control charging and discharging of the first battery and the second battery on the basis of whether the power is supplied to the external power supply connector when the coupler is being coupled to the display device.

According to an aspect of the present invention, there is provided with a computing device system including a computing device and a display device which can be coupled to and separated from the computing device,

the display device comprising:

a chargeable first battery; and

a first wireless communicator configured to communicate wirelessly with the computing device when being separated from the computing device, and

the computing device comprising:

a display device coupler configured to couple to the display device and be able to be separated from the display device, wherein charging to the chargeable first battery and wired communication with the display device can be performed via the display device coupler at a time of being coupled to the display device;

a coupling detector configured to detect whether the display device coupler is coupled to the display device;

a second wireless communicator configured to communicate wirelessly with the display device when the display device coupler is being separated from the display device;

an external power supply connector configured to be supplied with power from an external power supply;

a chargeable second battery;

a connection detector configured to detect whether power is supplied to the external power supply connector; and

a controller configured to control charging and discharging of the first battery and the second battery on the basis of whether the power is supplied to the external power supply connector when the display device coupler is being coupled to the display device.

According to an aspect of the present invention, there is provided with a power control method comprising:

detecting whether a computing device having a chargeable first battery and a display device having a chargeable second battery is separated or coupled each other, wherein
the display device and the computing device communicate wirelessly each other when being separated and perform wired communicate each other when being coupled, and
charging to the first battery from the computing device and charging to the second battery from the display device can be performed when being coupled;

detecting whether power from an external power supply is supplied to the computing device; and

controlling charging and discharging of the first battery and the second battery on the basis of whether the power is supplied from the external power supply when the display device and the computing device are being coupled each other.

### BRIEF DESCRIPTION OF THE DRAWINGS

FIG. 1 is a block diagram showing a configuration of a computing device system according to an embodiment of the present invention;

FIG. 2 is a block diagram showing another configuration of a computing device system according to an embodiment of the present invention;

FIG. 3 is a diagram showing representative modes in a computing device system according to an embodiment of the present invention;

FIG. 4 is a flow chart showing an example of power management in an embodiment of the present invention;

FIG. 5 is a flow chart showing another example of power management in an embodiment of the present invention; and

FIG. 6 is a diagram showing an example of power use history.

### DETAILED DESCRIPTION OF THE INVENTION

Hereafter, an embodiment of the present invention will be described with reference to the drawings.

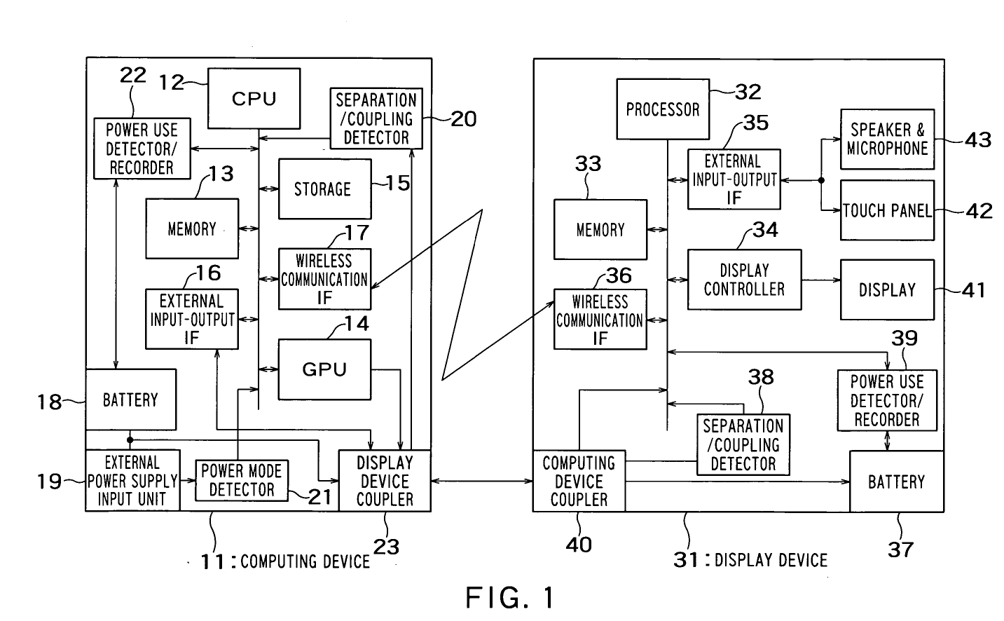

FIG. 1 is a block diagram showing a configuration of a computing device system according to an embodiment of the present invention. This computing device system includes a computing device 11 and a display device 31. The computing device 11 and the display device 31 can be separated from each other and coupled to each other. When separated, the computing device 11 and the display device 31 perform wireless communication via a wireless communication IF 17 and a wireless communication IF 36, respectively. When coupled, the computing device 11 and the display device 31 perform wired communication via a display device coupler 23 and a computing device coupler 40, and the computing device 11 and the display device 31 can supply power to each other via the display device coupler 23 and the computing device coupler 40. The computing device 11 includes a CPU (Central Processing Unit) 12, a memory 13, a GPU (Graphics Processing Unit) 14, a storage 15, an external input-output IF 16, a wireless communication IF 17, a chargeable battery 18, an external power supply input unit (external power supply connector) 19, a separation/coupling detector (a coupling detector) 20, a power mode detector 21, a power use detector/recorder 22, and a display device coupler 23 which couples the computing device 11 to the display device 31. The system architecture of the computing device is not especially restricted, but, for example, a system mounted on personal computers can be utilized.

The display device 31 includes a processor 32, a memory 33, a display controller 34, an external input-output IF 35, a wireless communication IF 36, a chargeable battery 37, a separation/coupling detector 38, a power use detector/recorder 39, a computing device coupler 40 which couples the computing device 11 to the display device 31, a display 41, a touch panel 42, and a speaker & microphone 43. The touch panel and the speaker & microphone are examples of external input-output devices.

In the computing device 11, an example of a single bus is shown for simplicity. However, it is also possible to provide a plurality of buses differing in demanded rate by using a chip set or the like. The display controller is incorporated in the GPU 14. It is also conceivable that the GPU itself is incorporated in the chip set. The memory 13 can be utilized not only as a main memory but also as a video memory. As a matter of course, a video memory may be connected to the GPU 14 besides the main memory. The external input-output IF 16 is provided to connect external input-output devices such as a USB (Universal Serial Bus), a UART (Universal Asynchronous Receiver Transmitter), an I₂S (Inter-IC Sound), an I₂C (Inter Integrated Circuit) and RS232C. As for the storage 15, a hard disk drive (HDD) which is a magnetic recording device can be mentioned as a representative example. However, a nonvolatile semiconductor storage such as a compact flash may also be used. In addition, a DVD, a CD, or an optical drive called multi drive may also be included in the storage 15 as external storages. It is also possible to connect the external storage to the external input-output IF 16. As the external input-output devices, there are a key board, a touch pad, a microphone, a speaker and various sensors.

Separation and coupling between the computing device 11 and the display device 31 depend on disconnection/coupling between the display device coupler 23 in the computing device 11 and the computing device coupler 40 in the display device 31. A state in which the computing device 11 and the display device 31 are separated from each other is referred to as separation mode, whereas a state in which the computing device 11 and the display device 31 are coupled to each other is referred to as coupling mode. Separation and coupling between the computing device 11 and the display device 31 mean disconnection and connection of at least a screen information line (wired communication path) and a power supply line respectively of the computing device 11 and the display device 31. If the display device 31 has an input part such as a touch panel, a speaker or a microphone, then an input-output line is also included in the wired communication path. Detection of separation and coupling between the computing device 11 and the display device 31 is performed by the separation/coupling detector 20 and the separation/coupling detector 38. However, an already known method such as a method disclosed in the above JP-A2002-304283(KOKAI) can be utilized.

The battery 18 and the battery 37 are mounted on the computing device 11 and the display device 31, respectively. In the computing device 11, the battery 18 and an external power supply connected to the external power supply input unit 19 supply operation power to the computing device 11. The battery 18 can be charged by using power of the external power supply connected to the external power supply input unit 19 or power supplied from the battery 37 in the display device 31. Furthermore, the computing device 11 can supply power from the external power supply connected to the external power supply input unit 19 and power of the battery 18 to the display device 31 via the display device coupler 23. The display device 31 can operate by using the power supplied from the computing device 11, and can charge the battery 37. Furthermore, the display device 31 can operate by using power of the battery 37. The battery 18 and the battery 37 are not especially restricted, as long as they can supply power for driving the computing device 11 and the display device 31 and they can be charged. As the most representative batteries, lithium ion batteries and lithium polymer batteries can be mentioned. Nickel hydrogen batteries can also be used although the energy density is low as compared with the lithium ion batteries.

The power mode detector 21 detects a power mode which represents whether an external power supply (for example, an AC adapter) is connected to the external power supply input unit 19. In the present embodiment, the case where the external power supply is connected is referred to as AC mode, and the case where the external power supply is not connected is referred to as battery mode. In other words, the computing device 11 has two major power modes: the AC mode and the battery mode. A distinction between the two modes is made depending upon whether the power supply which supplies operation power to the computing device 11 is the external power supply or the battery. In the AC mode, operation power is supplied from the external power supply. In the battery mode, operation power is supplied from the battery 18. Power mode detection in the power mode detector 21 can be performed by using a technique such as, for example, measurement of a voltage level of a signal from the external power supply or a signal from an electric or mechanical switch installed in the external power supply input unit 19.

The power use detector/recorder 22 records the power use situation in the computing device 11 successively as power use history. The power use detector/recorder 39 in the display device 31 records the power use situation in the display device 31 successively as power use history. In other words, power use in both batteries in the computing device and the display device (use history of battery 18 and use history of battery 37) is measured and recorded. By the way, the recording destination may be a semiconductor storage device or a magnetic recording device. In the case of a semiconductor storage device, a nonvolatile storage device is desirable. It is desirable to transmit the power use history of the battery stored in the display device 31 to the computing device 11 via the wireless communication IF 17 and the wireless communication IF 36 in the separation state or the display device coupler 23 and the computing device coupler 40 in the coupling state and store the power use history in the display device 31 on the computing device 11 side as well.

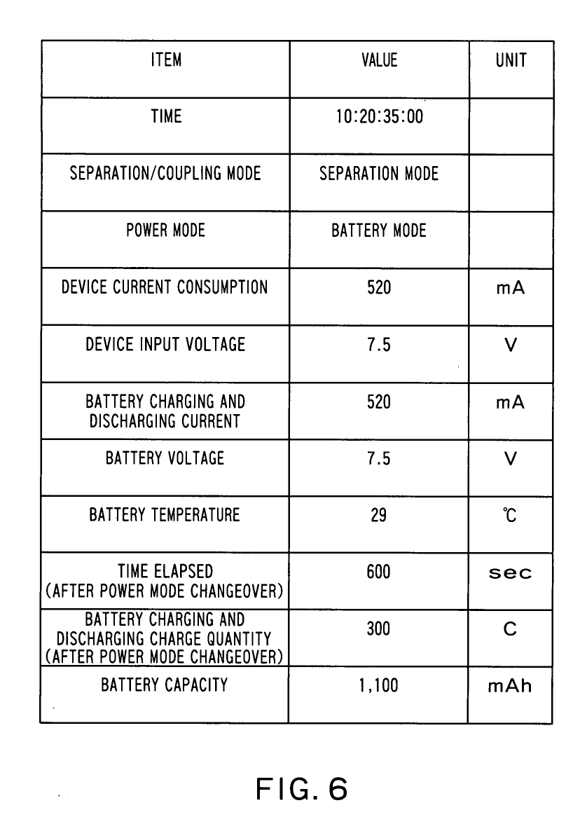

FIG. 6 shows an example of data of history of power use measured and recorded, at certain time.

In FIG. 6, the product of “device current consumption” and “device input voltage” becomes “device power consumption” at that time point. When calculating average power consumption of a subject device, a subject time period of averaging is set by referring to “time” in recording items. When considering “power mode” changeover, “elapsed time (after power mode changeover)” should be referred to. “Battery charging/discharging charge quantity (after power mode changeover)” is a value obtained by performing time integral on a value of “battery charging/discharging current” after power mode changeover. “Battery voltage” is measured to prevent overcharging and overdischarging. “Battery temperature” is measured for a safety reason that temperature abnormality should be detected and in order to take temperature correction of charging and discharging characteristics into consideration as occasion demands. “Battery capacity,” exactly speaking, battery current capacity is a nominal battery capacity. This value may be acquired together with a nominal battery voltage on the basis of information of a battery pack at the time of battery exchange. The nominal battery voltage is omitted in FIG. 6. A residual battery capacity (not shown) can be calculated on the basis of the battery charging and discharging charge quantity and the battery capacity.

The output scheme of a video signal from the GPU 14 in the computing device 11 and the display controller 34 in the display device 31 is not especially restricted, as long as the output scheme conforms to the input scheme of the display 41 which is the output destination. As the representative scheme, the analog RGB, digital parallel, LVDS (Low Voltage Differential Signaling), TMDS (Transmission Minimized Differential Signaling), and HDMI (High Definition Multimedia Interface) can be mentioned.

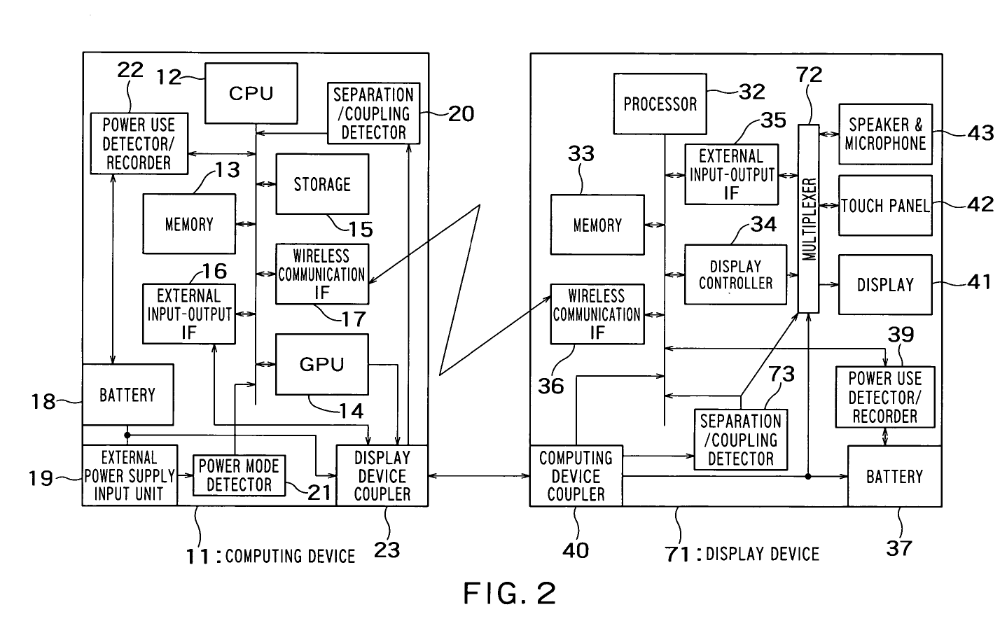

As for the wireless communication IF 17 and the wireless communication IF 36, for example, the wireless LAN, Bluetooth, UWB (Ultra Wide Band), PHS and portable telephone can be mentioned. However, the wireless communication IF 17 and the wireless communication IF 36 are not especially restricted. When the computing device 11 and the display device 31 are in the separated state, data communication is performed between the wireless communication IF 17 and the wireless communication IF 36. When the computing device 11 and the display device 31 are in the coupled state, data communication is performed between the computing device 11 and the display device 31 via the display device coupler 23 and the computing device coupler 40. The display controller 34 receives image information from the wireless communication IF 36 or the computing device coupler 40 via the processor 32 or directly, generates a video signal on the basis of the received image information, and outputs the video signal to the display 41. The external input-output IF 35 outputs an input signal from the speaker & microphone 43 or the touch panel 42 to the wireless communication IF 36 or the computing device coupler 40 via the processor 32 or directly. A configuration including a multiplexer 72 in the display device as shown in FIG. 2 is also possible. The multiplexer 72 in a display device 71 is supplied with a signal which represents the separation mode or the coupling mode from a separation/coupling detector 73. If the multiplexer 72 is supplied with a signal which represents the coupling mode, the multiplexer 72 outputs a video signal supplied from the computing device coupler 40 to the display 41, and outputs an input signal from the speaker & microphone 43 or the touch panel 42 to the computing device coupler 40. On the other hand, if the multiplexer 72 is supplied with a signal which represents the separation mode, the multiplexer 72 outputs a video signal supplied from the display controller 34 to the display 41, and outputs an input signal from the speaker & microphone 43 or the touch panel 42 to the external input-output IF 35.

The display 41 mounted on the display device 31 is not especially restricted, as long as it can display screen information supplied from the computing device 11. As displays mounted on a large number of notebook computers at the present time, transmissive liquid crystal display devices (LCD) can be mentioned. There are various schemes for the transmissive LCD as well. However, the schemes are not restrictive. Besides the LCD, an emissive display device such as an organic EL device or an inorganic EL device may also be used. A reflective display device may also be used as a display device which implements lower power consumption. As the reflective display device, a reflective LCD may be used, or an electrophoretic display device or a reflective display device utilizing the MEMS technique can also be utilized. In addition, not only a direct-view display device described heretofore, but also a projection display device may be utilized. Depending upon the size and shape of the computing device, a wearable display device such as a head mount wearable display device can also be used.

The CPU (controller) 12 included in the computing device 11 performs power management for the computing device 11 and the display device 31. Specifically, the CPU 12 controls charging and discharging in the battery 18 in the computing device 11 and the battery 37 in the display device 31. As for the charging and discharging control, there are three broad charging methods: charging the battery 37 in the display device 31 preferentially (preferential charging), charging the battery 18 in the computing device 11 preferentially, and charging the battery 18 in the computing device 11 and the battery 37 in the display device 31 with good balance (balanced charging), i.e., charging without giving priority to either the battery 37 or 18. Each of the charging and discharging methods may be controlled more finely. Supposing the battery mode, in the balanced charging, charging and discharging of the batteries 37 and 18 are controlled on the basis of the power use histories of the display device 31 and the computing device 11 so as to make discharge time periods of the batteries 37 and 18 respectively in the display device 31 and the computing device 11 equal as far as possible, i.e., so as to make drive time periods of the display device 31 and the computing device 11 equal as far as possible. In other words, charging and discharging of the batteries 37 and 18 are controlled so as to cause the residual quantity of the battery 18 and the residual quantity of the battery 37 to satisfy a balance condition. Details of the preferential charging and balanced charging will be described later.

Hereafter, power management in the computing device system shown in FIG. 1 will be described in detail.

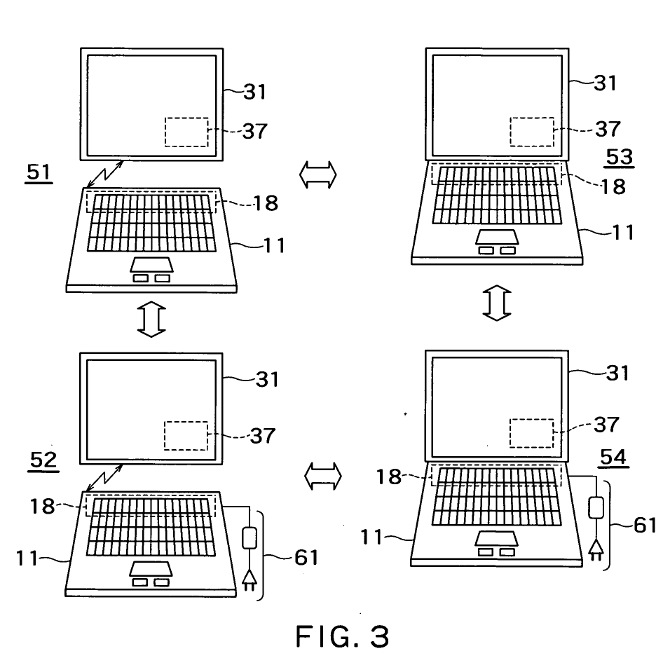

FIG. 3 represents transitions among various states of the computing device system including the display device 31 and the computing device 11.

In a state 51 of the separation mode and the battery mode, the display device 31 operates using power supplied from the battery 37 and the computing device 11 operates using power supplied from the battery 18.

If an external power supply, such as an AC adapter 61, is connected to the computing device 11 in the state 51 of the separation mode and the battery mode, then transition to a state 52 of the separation mode and the AC mode is performed.

If the display device 31 is coupled to the computing device 11 in the state 51 of the separation mode and the battery mode, transition to a state 53 of the coupling mode and the battery mode is performed.

If the AC adapter 61 is connected to the computing device 11 in the state 53 or the display device 31 is coupled to the computing device 11 in the state 52, then transition to a state 54 of the coupling mode and the AC mode is performed.

Thus, the computing device system including a separable display device has two modes (the separation mode and the coupling mode) concerning the coupling relation between the computing device and the display device and two modes (the AC mode and the battery mode) concerning the power supply form. As a result, the computing device system can assume the four states 51 to 54 obtained by combining the modes.

The batteries 18 and 37 are mounted on the computing device 11 and the display device 31, respectively. Power management concerning the battery charging and discharging becomes extremely important in ensuring the continuous operation time of the computing device system. For example, if the computing device system continues to be utilized in the state 51 of the separation mode and the battery mode, then it is usually desirable that the computing device 11 supplied with power from the battery 18 becomes nearly in operation time to the display device 31 supplied with power from the battery 37. Therefore, it becomes necessary to control the charging and discharging of the batteries 18 and 37 in the coupling mode (the states 53 and 54) by taking, for example, the residual battery capacities of the batteries 18 and 37 and power consumption of the computing device 11 and the display device 31 into consideration. In particular, since the power consumption quantity of the computing device 31 varies largely according to its utilization method, it is desirable to reflect the power use history over a certain definite time period into the power management.

In general, it is indispensable in obtaining high convenience of use of the system that the user can utilize the computing device system while separating and coupling the display device and performing transition between the battery mode and the AC mode without being conscious of the power management. On the other hand, there are various demands for the power management according to different user's utilization methods, and it also becomes important that the user can perform power management setting manually as occasion demands.

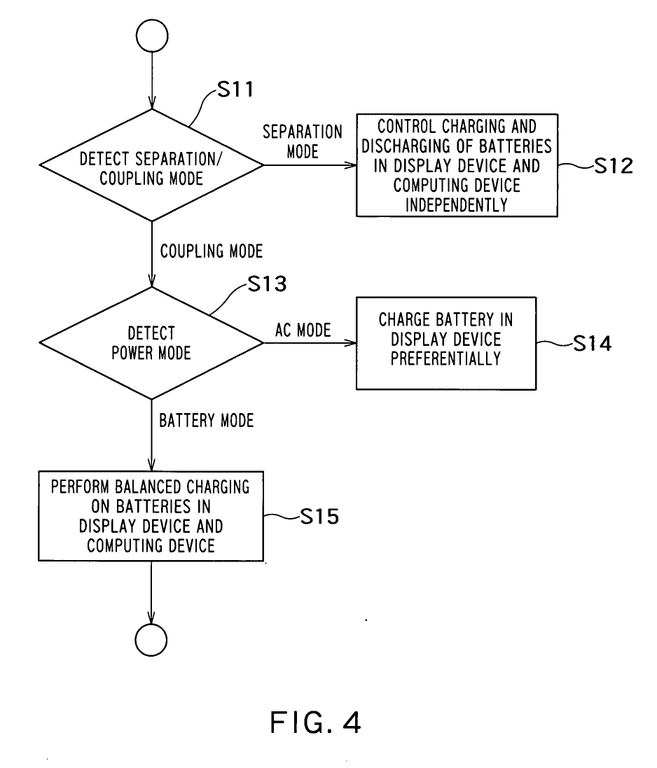

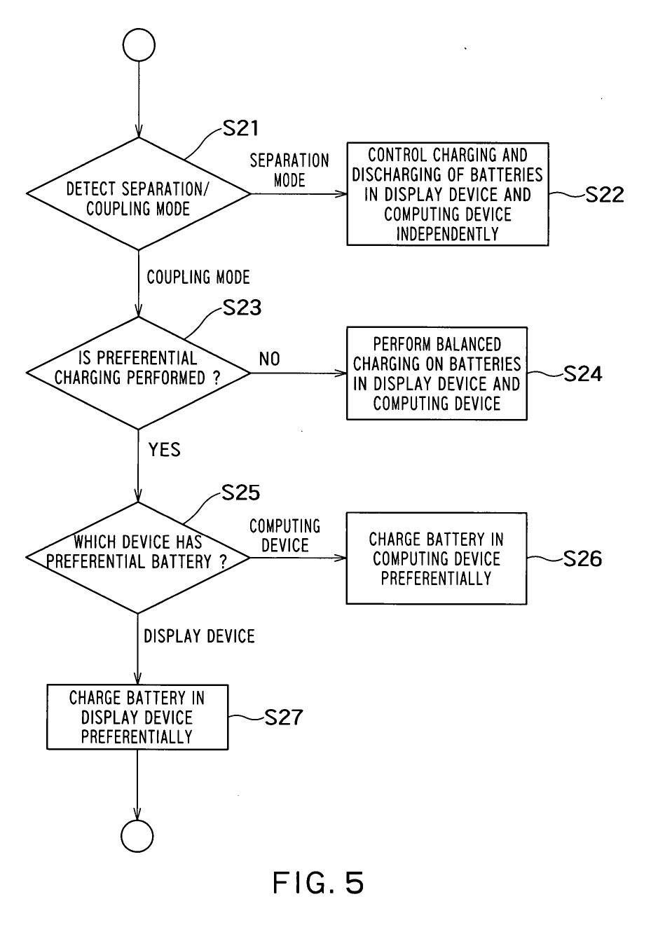

FIGS. 4 and 5 are flow charts showing examples of a power management processing according to an embodiment of the present invention. FIG. 4 shows the case where the charging and discharging control is exercised automatically. FIG. 5 shows the case where the charging and discharging control is exercised manually.

In FIG. 4, the separation/coupling mode which represents whether the display device 31 and the computing device 11 are in the separated state or in the coupled state (S11).

If the separation mode is detected (separation mode at S11), charging and discharging of the batteries 37 and 18 respectively mounted on the display device 31 and the computing device 11 should be controlled independently (S12). By the way, power is measured at all times, and its result is recorded. In the case of the separation mode, the battery 37 and the battery 18 are electrically independent. Even if the separation mode and the AC mode are combined, therefore, charging and discharging control should be performed on respective batteries as usual. For example, in the charging and discharging control of the computing device in the state of the separation mode and the AC mode, the charging current should be controlled while detecting the battery voltage, the charging and discharging charge quantity and the battery temperature considered in charging of the ordinary secondary battery. Charging control differs depending upon the kind of the battery. Typically, in the case of the lithium ion battery usually utilized in PCs (Personal Computers), quick charging using constant current control is performed over a range of approximately 80 to 85% of the nominal battery capacity, and then full charging using constant voltage control with the full charging voltage of the battery is performed. The quick charging is performed typically with a current quantity of 0.5 C to 1 C. A current quantity at which the discharging finishes after one hour is referred to as 1 C. For example, if the nominal battery capacity is 1,100 mAh as shown in FIG. 6, 1,100 mA becomes 1 C.

On the other hand, if the coupling mode is detected (coupling mode at S11), the power mode is detected as the next step (S13). If the AC mode is detected (AC mode at S13), the battery 37 in the display device 31 is charged preferentially (S14). The reason is that the computing device 11 is operated in the AC mode in some cases whereas the display device 31 is operated basically in the battery mode from the viewpoint of improvement of convenience in user's use.

If the battery mode is detected (battery mode at S13), then it is typically desirable that the display device 31 supplied with power from the battery 37 becomes nearly equal in operation time to the computing device 11 supplied with power from the battery 18 as described above. Therefore, balanced charging is performed on the basis of the power use histories of the display device 31 and the computing device 11 (S15).

In FIG. 5 which shows the case where the charging and discharging control is exercised manually, if the separation mode is detected (separation mode at S21) as a result of the detection of the separation/coupling mode (S21), then charging and discharging of the batteries 37 and 18 respectively mounted on the display device 31 and the computing device 11 are controlled independently in the same way as automatic control (S22).

If the coupling mode is detected (coupling mode at S21), the user specifies whether to perform preferential charging (S23). If specification data input from the user indicates that preferential charging should not be performed (no at S23), then balanced charging is performed (S24).

On the other hand, if specification data indicates that preferential charging should be performed (yes at S23), the user inputs specification data which specifies a subject of the preferential charging (S25).

If the computing device 11 is specified (computing device at S25), the battery 18 in the computing device 11 is charged preferentially (S26). If the display device 31 is specified (display device at S25), the battery 37 in the display device 31 is charged preferentially (S27). At this time, specified one may be charged with preference of 100% (charged preferentially until the battery capacity reaches a prescribed value), or the degree of preference may be changed manually by the user.

Hereafter, a processing flow in the case where the charging and discharging control shown in FIG. 4 is exercised automatically will further be described with reference to a concrete example.

It is now supposed that a TFT color LCD with 12.1 inch XGA, an electromagnetic touch panel, a wireless LAN circuit conforming to IEEE 802.11g, a video processing circuit, an LCD control circuit, a power supply circuit, and a 10-Wh lithium ion battery are mounted on the display device.

It is now supposed that a central processing unit (CPU) having an operation frequency of 1.5 GHz, a 512-MB main memory, a graphics processing unit (GPU) having an operation frequency of 400 MHz, an 80-GB hard disk drive (HDD), a DVD multi-drive, a keyboard, a touch pad, a speaker, a wireless LAN circuit conforming to IEEE 802.11g, and a 40-Wh lithium ion battery are mounted on the computing device.

It is first supposed that the display device is separated from the computing device and the separation mode is detected (separation mode at S11). The separation/coupling mode detection is performed by judging a state of an electric switch attached to a connector which couples the display device to the computing device. If the display device is separated from the computing device, it becomes possible for the user to hold only the display device and use it. Screen data is sent from the computing device to the display device via the wireless LAN. Control signals from the electromagnetic touch panel and data signals are also transmitted and received between the display device and the computing device via the wireless LAN. The display device is supplied with power from the lithium ion battery included therein and the computing device is supplied with power from the lithium ion battery included therein.

It is then supposed that the display device is coupled to the computing device and the coupling mode is detected (coupling mode at S11). In the coupling mode, it becomes possible to utilize the computing device and the display device as an ordinary all-in-one notebook computer. Screen data is sent from the computing device to the display device in a wire form. Control signals from the electromagnetic touch panel and data signals are also transmitted and received between the display device and the computing device in a wire form. Furthermore, a power line of the display device is connected to a power line of the computing device.

If the coupling mode is detected, then it is detected whether an AC adapter is connected, i.e., the power mode is detected by judging the state of the electric switch included in an AC adapter connector (the external power supply input unit) in the computing device (S13).

If the AC mode is detected as the power mode (AC mode at S13), then power is supplied from the AC adapter to bring the display device and the computing device into operation and the battery mounted on the display device is charged preferentially (S14). In other words, the battery in the computing device is not charged, but the battery in the display device is subjected to quick charging. After charging corresponding to 80% or more of the nominal battery capacity has been completed, the battery in the computing device is subject to quick charging.

If the battery mode is detected as the power mode (battery mode at S13), balanced charging and discharging are performed on the basis of power use histories of the display device and the computing device recorded at the time of the separation mode, so as to make the operation time of the display device nearly equal to that of the computing device in the separation mode at the next time (S15). For example, if the battery in the display device needs to be charged, the battery in the display device is charged from the battery in the computing device and the battery in the computing device supplies power to both the computing device and the display device for their operation. On the contrary, if the battery in the computing device needs to be charged, the battery in the computing device is charged from the battery in the display device and the battery in the display device supplies power to both the computing device and the display device for their operation.

Hereafter, details of the balanced charging and the preferential charging will be described.

First, a method of balanced charging will now be described with respect to the lithium ion battery ordinarily utilized in personal computers. The balanced charging means charging and discharging the batteries in the display device and the computing device so as to satisfy the balance condition and a content of the balance condition is for example stored in the storage 15. Hereafter, a detailed example of a balanced charging method will be described.

An average power consumption of each of the display device and the computing device is calculated on the basis of the power use history obtained by recording measurement results of power use as shown in FIG. 6. A sum of them is an average power consumption of the whole system. A subject time period of the averaging may be set manually by the user or may be preset automatically equal to, for example, 30 minutes. On the other hand, the residual battery capacities of the batteries respectively in the display device and the computing device are found from FIG. 6. The product of the residual battery capacity and the nominal voltage becomes a residual power capacity. The sum of the residual power capacities of the display device and the computing device becomes a residual power capacity of the whole system at the time when the display device is coupled to the computing device.

With respect to the battery in the display device, the target of balanced charging in the battery mode becomes a power capacity found as “residual power capacity of the whole system”×(average power consumption in display device÷average power consumption in whole system). A value obtained by dividing the target power capacity by the nominal voltage becomes a target residual battery capacity. With respect to the battery in the computing device as well, a target residual battery capacity is calculated in the same way. Charging or discharging is performed on the basis of comparison with the residual battery capacity at that time point. As for charging, quick charging using constant current control or full charging using constant voltage control is performed according to the above-described criterion. If the display device is coupled to the computing device and the system is in operation, then a battery having a residual battery at that time point greater than the target residual battery capacity supplies power utilized in the whole system, i.e., in both the display device and the computing device and charges the other battery. After the target residual battery capacity is reached, each device is supplied with power from the battery mounted on the device.

The target of balanced charging in the AC mode is that the ratio between the residual power capacities of the batteries in the display device and the computing device becomes the ratio between average power consumptions of the devices. As a matter of course, if one of the batteries is fully charged, then the other is charged to be fully charged. As long as an external power supply capable of supplying the sum total of the power consumption of the whole system and power capable of performing quick charging on both batteries is connected, however, both batteries in the display device and the computing device may be subject to quick charging.

In the embodiment of the present invention, preferential charging is charging one of the batteries in the display device and the computing device. One of the batteries is subject to the above-described quick charging, and the other is not charged. In the case of the lithium ion batteries in the AC mode, the battery subjected to preferential charging is shifted to the above-described constant voltage control and thereafter the other battery is subject to quick charging. As a matter of course, both batteries in the display device and the computing device may be subject to quick charging, as long as an external power supply capable of supplying the sum total of the power consumption of the whole system and power capable of performing quick charging on both batteries is connected. In the battery mode, the battery that is not the subject of the preferential charging supplies the power consumption of the whole system and charges the battery that becomes the subject of the preferential charging.

According to the embodiment of the present invention, it becomes possible to effectively perform power management on batteries respectively mounted on the display device and the computing device which can be separated from and coupled to each other, as heretofore described.

What is claimed is:

1. A computing device comprising:
a coupler configured to couple to a display device having a chargeable first battery and be able to be separated from the display device, wherein charging to the first battery and wired communication with the display device can be performed via the coupler at a time of being coupled to the display device;
a coupling detector configured to detect whether the coupler is coupled to the display device;
a wireless communicator configured to communicate wirelessly with the display device when the coupler is being separated from the display device;
an external power supply connector configured to be supplied with power from an external power supply;
a chargeable second battery;
a connection detector configured to detect whether power is supplied to the external power supply connector; and
a controller configured to control charging and discharging of the first battery and the second battery on the basis of whether the power is supplied to the external power supply connector when the coupler is being coupled to the display device.

2. The computing device according to claim 1, further comprising a power use recorder configured to record use history of the chargeable second battery,
wherein the controller acquires use history of the chargeable first battery from the display device via the coupler, and controls charging and discharging of the first battery and the second battery by using the use history of the chargeable second battery and the use history of the chargeable first battery.

3. The computing device according to claim 2, wherein the controller controls charging and discharging of the first battery and the second battery so as to satisfy a balance condition given in advance.

4. The computing device according to claim 3, wherein when power is supplied to the external power supply connector, the controller charges the first battery and the second battery by using power from the external power supply so as to cause a ratio between a residual battery capacity of the first battery and a residual battery capacity of the second battery to coincide with a ratio between first average power consumption calculated from the use history of the chargeable first battery and second average power consumption calculated from the use history of the chargeable second battery.

5. The computing device according to claim 4, wherein when power is not supplied to the external power supply connector, the controller
calculates a battery capacity to be left in each of the first and second batteries as target residual battery capacities on the basis of the residual battery capacity of the first battery, the residual battery capacity of the second battery, the first average power consumption and the second average power consumption, and
uses power of battery whose current residual battery capacity exceeds the target residual battery capacity to charge the other battery.

6. The computing device according to claim 5, wherein when any one of the first and second batteries has reached the target residual battery capacity, the controller stops the charging.

7. The computing device according to claim 1, wherein the controller charges one of the first battery and the second battery preferentially.

8. The computing device according to claim 7, wherein when power is supplied to the external power supply connector, the controller charges one of the first battery and the second battery preferentially by using power of the external power supply.

9. The computing device according to claim 7, wherein when power is not supplied to the external power supply connector, the controller charges battery given to priority, by using power of the other battery.

10. The computing device according to claim 1, further comprising an input unit configured to input indication data indicating any charging scheme selected from among first preferential charging in which the first battery is charged preferentially, second preferential charging in which the second battery is charged preferentially, and balanced charging in which the first and second batteries are charged so as to satisfy a balance condition given in advance,
wherein the controller controls charging and discharging of the first and second batteries on the basis of the indication data and whether the power is supplied to the external power supply connector.

11. A computing device system including a computing device and a display device which can be coupled to and separated from the computing device,
the display device comprising:
a chargeable first battery; and
a first wireless communicator configured to communicate wirelessly with the computing device when being separated from the computing device, and
the computing device comprising:
a display device coupler configured to couple to the display device and be able to be separated from the display device, wherein charging to the chargeable first battery and wired communication with the display device can be performed via the display device coupler at a time of being coupled to the display device;
a coupling detector configured to detect whether the display device coupler is coupled to the display device;
a second wireless communicator configured to communicate wirelessly with the display device when the display device coupler is being separated from the display device;
an external power supply connector configured to be supplied with power from an external power supply;
a chargeable second battery;
a connection detector configured to detect whether power is supplied to the external power supply connector; and
a controller configured to control charging and discharging of the first battery and the second battery on the basis of whether the power is supplied to the external power supply connector when the display device coupler is being coupled to the display device.

12. A power control method comprising:
detecting whether a computing device having a chargeable first battery and a display device having a chargeable second battery is separated or coupled each other, wherein
the display device and the computing device communicate wirelessly each other when being separated and perform wired communicate each other when being coupled, and
charging to the first battery from the computing device and charging to the second battery from the display device can be performed when being coupled;
detecting whether power from an external power supply is supplied to the computing device; and
controlling charging and discharging of the first battery and the second battery on the basis of whether the power is supplied from the external power supply when the display device and the computing device are being coupled each other.

13. The method according to claim 12, further comprising recording use history of the chargeable first battery and the chargeable second battery,
wherein the controlling includes controlling charging and discharging of the first battery and the second battery by using the use histories of the chargeable first battery and the chargeable second battery.

14. The method according to claim 13, wherein when power is supplied to the computing device, the controlling includes charging the first battery and the second battery by using power from the external power supply so as to cause a ratio between a residual battery capacity of the first battery and a residual battery capacity of the second battery to coincide with a ratio between average power consumption of the display device and average power consumption of the computing device.

15. The method according to claim 14, wherein when power is not supplied to the computing device, the controlling includes
calculating a battery capacity to be left in each of the first and second batteries as target residual battery capacities on the basis of the residual battery capacity of the first battery, the residual battery capacity of the second battery, the average power consumption of the display device and the average power consumption of the computing device, and
using power of battery whose current residual battery capacity exceeds the target residual battery capacity to charge the other battery.

16. The method according to claim 15, wherein when any one of the first and second batteries has reached the target residual battery capacity, the controlling includes stopping the charging.

17. The method according to claim 12, wherein the controlling includes charging one of the first battery and the second battery preferentially.

18. The method according to claim 17, wherein when power is supplied to the computing device, the controlling includes charging one of the first battery and the second battery preferentially by using power of the external power supply.

19. The method according to claim 17, wherein when power is not supplied to the computing device, the controlling includes charging battery given to priority, by using power of the other battery.

20. The method according to claim 12, further comprising inputting indication data indicating any charging scheme selected from among first preferential charging in which the first battery is charged preferentially, second preferential charging in which the second battery is charged preferentially, and balanced charging in which the first and second batteries are charged so as to satisfy a balance condition given in advance,
wherein the controlling includes controlling charging and discharging of the first and second batteries on the basis of the indication data and whether the power is supplied to the computing device.
